(19) United States
(12) Patent Application Publication
(10) Pub. No.: US 2003/0112846 A1
(43) Pub. Date: Jun. 19, 2003

(54) Thermometer

(76) Inventor: Richard James Murtagh, Portland, OR (US)

Correspondence Address: Kolisch, Hartwell, Dickinson,, McCormack & Heuser, 200 Pacific Building, 520 S.W. Yamhill Street, Portland, OR, 97204, US

(21) Appl. No.: 10/027,640

(22) Filed: Dec. 19, 2001

(51) Int. Cl. G01K 1/14; G01K 13/00; G01K 5/62

(52) U.S. Cl. 374/149; 374/207

(57) ABSTRACT

A thermometer configured to measure the temperature of a medium. The thermometer typically includes a temperature sensor positioned within a sealed sensor chamber. The sensor chamber, in turn, is positioned within a heat storage chamber. The heat storage chamber contains a thermal insulator. Heat energy thus is exchanged between the medium and the temperature sensor through the thermal insulator contained within the heat storage chamber so as to slow reaction of the temperature sensor.

### TECHNICAL FIELD

This invention relates generally to thermometers, and more particularly to thermometers for use in temperature-controlled environments.

### BACKGROUND OF THE INVENTION

Thermometers often are used to measure the ambient temperature within refrigerators, ovens, and other devices with temperature-controlled compartments. Typically, these thermometers are small devices with a temperature probe and readout, and are designed to be placed entirely within the temperature-controlled compartment to measure the operating temperature of the compartment. On certain devices equipped with access doors and glass windows, it may be possible to position such a thermometer near the glass window, such that the readout may be viewed by a user without opening the door. On many other devices, however, the access door does not have a window, and the thermometer can be read only by opening the access door, and looking at the thermometer inside the compartment.

One problem with current oven and refrigerator thermometers is that air currents caused by opening the door of the oven or refrigerator often change the temperature of the air adjacent the thermometer, affecting the temperature measurement by the thermometer. For example, when a refrigerator is opened, warm air may enter and travel to the thermometer, causing the thermometer to indicate a temperature higher than the actual temperature of the refrigerator prior to opening the door. Similarly, cool air may enter through an oven door and cause an oven thermometer to indicate a lower temperature than the actual operating temperature of the oven before the door was opened. Erroneous temperature readings can cause users to set their refrigerators to unnecessarily cool levels, thereby wasting electricity and/or inadvertently freezing the contents of the refrigerator. Likewise, an oven user may set the heat of the oven too high based on an erroneous temperature reading and bum or overcook the oven contents.

It would be desirable to provide a thermometer capable of providing a stable, accurate reading of the temperature of an oven, refrigerator, or other device, without significant interference from air currents caused by opening the door of such a device.

### SUMMARY OF THE INVENTION

A thermometer configured to measure the temperature of a medium is provided. The thermometer typically includes a sensor chamber and a temperature sensor positioned within the sensor chamber. The thermometer may also include a heat storage chamber positioned adjacent the sensor chamber. The temperature sensor is typically thermally coupled to the medium through the sensor chamber and the heat storage chamber such that heat energy may be exchanged between the medium and the temperature sensor. The heat storage chamber may be bounded by an outer wall and an inner wall, and may contain a liquid such as hydraulic fluid.

The thermometer also may be used to measure the operating temperature of a compartment having a door, where opening the door of the compartment alters the temperature of the compartment. The thermometer may include a temperature sensor and an indicator coupled to the temperature sensor. Typically, the indicator is configured to indicate a temperature value measured by the temperature sensor. The thermometer also may include a double-walled probe with an inner wall and an outer wall substantially surrounding the inner wall. A space between the outer wall and the inner wall may define a heat storage chamber filled with a liquid (e.g., an oil such as hydraulic fluid), and a space within the inner wall may define a sensor chamber filled with air. The temperature sensor typically is positioned within the sensor chamber, the heat storage chamber typically being configured to insulate the sensor chamber and temperature sensor from intermittent temperature fluctuations caused by opening the door of the compartment.

In addition, the compartment may include a rack, and the thermometer may employ a clip. The clip typically includes a probe-receiving bore at one end, and a rack-receiving bore at an opposite end. The probe-receiving bore may be configured to mount to the probe. The rack-receiving bore is configured to mount to the rack to selectively secure the thermometer to the rack.

### BRIEF DESCRIPTION OF THE DRAWINGS

FIG. 1 is a front cross-sectional view of a thermometer according to one embodiment of the present invention.

FIG. 2 is an isometric view of a temperature-controlled device which contains a pair of thermometers variously attached to an internal rack.

### DETAILED DESCRIPTION OF THE PREFERRED EMBODIMENTS

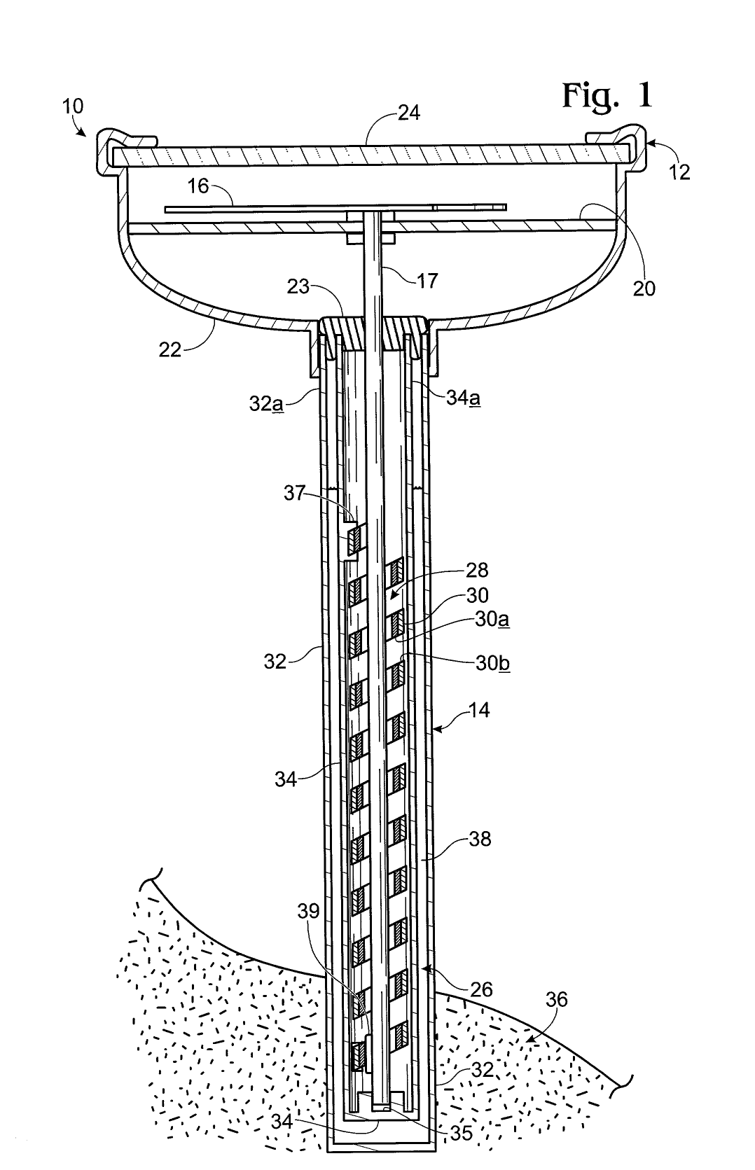

Referring initially to FIG. 1, a thermometer according to one embodiment of the present invention is shown generally at 10. Thermometer 10 typically includes an indicator 12 coupled to a temperature probe 14. Indicator 12 is configured to display a temperature value corresponding to a temperature sensed by temperature probe 14.

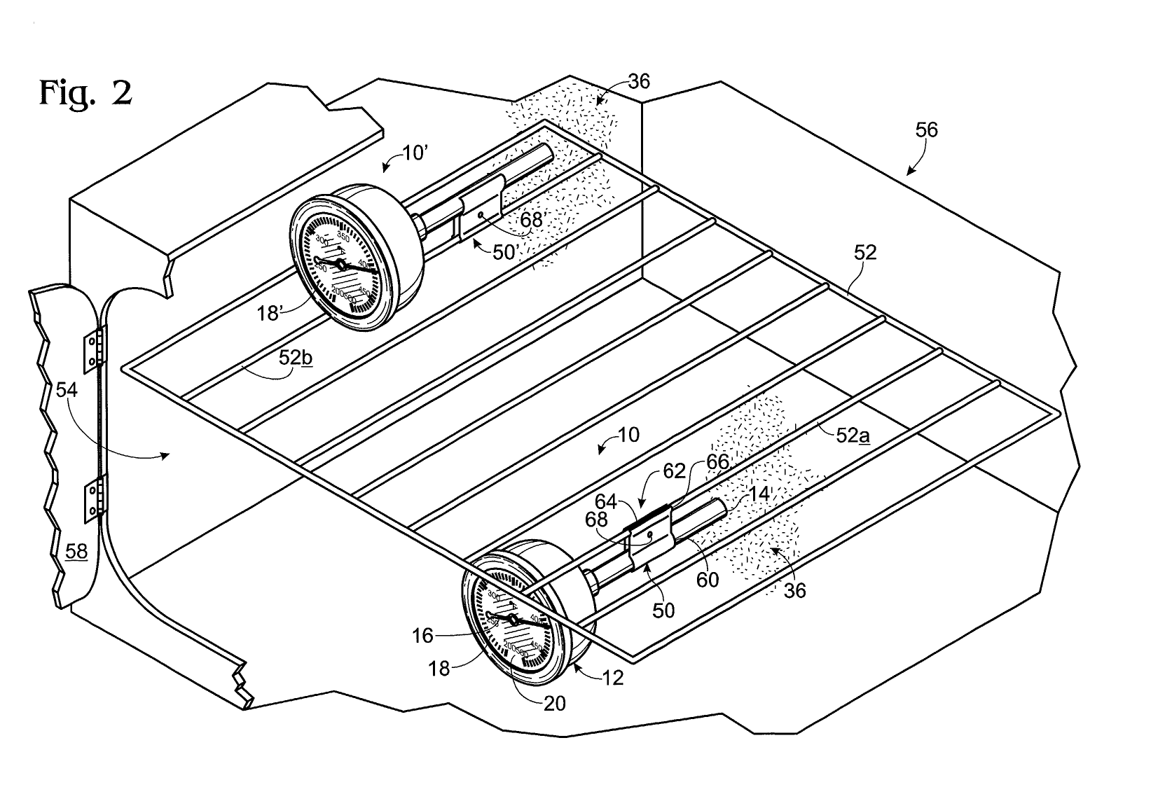

As shown in FIG. 2, indicator 12 typically is a dial indicator, and includes a needle 16 configured to rotate and point to a temperature value depicted on temperature scale 18 of face 20. The temperature scale may include numerals and scoring marks and typically is configured to indicate temperature values on a Fahrenheit temperature scale. Alternatively, the temperature scale may be a Celsius temperature scale, or another predetermined temperature scale. In addition, colored bands or other indicia may be used instead of numerals and/or scoring marks to indicate temperature ranges.

Referring again to FIG. 1, it will be appreciated that indicator 12 also typically includes a frame portion 22 partially surrounding needle 16, and a glass portion 24 through which needle 16 and temperature scale 18 may be read by a user. Alternatively, indicator 12 may be another type of analog indicator, such as a linear scale, or may be a digital indicator (e.g., digits on an LCD screen), or may be some other type of device capable of indicating a temperature value to a user.

Probe 14 typically includes a heat storage chamber 26, a sensor chamber 28, and a temperature sensor 30 disposed within the sensor chamber. Accordingly, probe 14 is typically of a double-walled construction, including an outer wall 32 and an inner wall 34. The walls are constructed from a rigid heat-conductive material, typically stainless steel. Outer wall 32 and inner wall 34 typically are attached to frame 22 of indicator 12 via a collar 23 adjacent respective top ends 32a, 34a.

As indicated, outer wall 32 substantially encloses and surrounds inner wall 34. The space between outer wall 32 and inner wall 34 defines the heat storage chamber 26. The space within, and bounded by, inner wall 34 defines sensor chamber 28. Heat storage chamber 26 thus at least partially surrounds sensor chamber 28 and temperature sensor 30. In one embodiment of the invention, heat storage chamber 26, in combination with frame 22 of indicator 12, completely surrounds sensor chamber 28 and temperature sensor 30. For example, in the present embodiment, the heat storage chamber and sensor chamber form concentric cylinders wherein the interior, cylindrical sensor chamber 28 is completely encased within the exterior, cylindrical heat storage chamber 26. Alternatively, heat storage chamber 26 and sensor chamber 28 may be formed in another shape.

Heat storage chamber 26 is positioned adjacent sensor chamber 28 intermediate temperature sensor 30 and a medium 36 to be measured. Typically, medium 36 is an environment or atmosphere within an oven, refrigerator, or other device. Alternatively, medium 36 may be a material, such as a roast, stew, frozen food, or other heated or cooled object.

Typically, temperature sensor 30 is a bimetallic strip, formed in a helical shape. Those skilled in the art will recognize that bimetallic strips are formed of joined metal halves 30a, 30b. The metal halves each are formed of a different metal composition, and have different rates of thermal expansion, which causes the strip to wind and unwind in response to temperature changes at a predetermined rate. One example of a suitable bimetallic strip is disclosed in U.S. Pat. No. 4,211,114 to Hood, the disclosure of which is herein incorporated by reference.

Typically, bimetallic strip 30 is joined to inner wall 34 at a first coupling 37, and to shaft 17 at a second coupling 39. Shaft 17 is rotatably mounted within collar 23 and cavity 35. As bimetallic strip 30 winds and unwinds in response to temperature changes, shaft 17 is caused to rotate. Needle 16, it will be noted, is mounted to shaft 17, and also rotates as the bimetallic strip winds and unwinds, thereby indicating a temperature value on the temperature scale 18 of face 20.

Heat storage chamber 26 typically contains a liquid, such as hydraulic oil or hydraulic fluid, and thus also is referred to as liquid chamber 26. Alternatively, virtually any other liquid configured to withstand the temperatures being measured may be used. For example, an oil such as food-grade cooking oil, bean oil, mineral oil, or another suitable oil may be used. Alternatively, heat storage chamber 26 may be filled with a non-liquid material capable of storing heat energy, such as a powder. In one embodiment of the invention, a graphite power is used. As indicated, heat storage chamber 26 typically is filled to a level which will accommodate expansion of the liquid or non-liquid with expected variations in temperature. Temperature sensor 30 typically is contained entirely within such liquid or non-liquid.

In accordance with the invention, it will be appreciated that the liquid increases the thermal mass of heat storage chamber 26, as compared to an air-filled chamber. The heat storage chamber thus is configured to absorb heat energy from medium 36. Accordingly, the thermal mass of the liquid slows the speed at which heat is transferred from environment 36 to temperature sensor 30. Therefore, heat storage chamber 26 acts as a stabilizer, causing thermometer 10 to indicate a substantially stable temperature reading when exposed to brief fluctuations in temperature, such as occurs when a refrigerator or oven door is opened by a user to read the thermometer.

The heat storage chamber has a heat capacity sufficient to maintain the temperature of the temperature sensor substantially at the temperature of the medium for a predetermined period of time when the temperature of the medium fluctuates. Typically, the predetermined period of time is less than about 3 minutes. In one preferred embodiment of the invention, the predetermined period of time is between about 30 and 90 seconds.

As shown in FIG. 2, the thermometer of the present invention also may include an elongate clip 50 configured to attach, at one end, to probe 14 and, at an opposite end, to a rack 52 within compartment 54 of temperature-controlled device 56. Typically, temperature-controlled device 56 is an oven. Alternatively, temperature-controlled device 56 may be a refrigerator, or other device configured to heat or cool a compartment or to keep a compartment within a predetermined temperature range. Typically, temperature-controlled device 56 includes a door 58 allowing a user access to compartment 54. Door 58 may be opened to read thermometer 10 and check the temperature of compartment 54. Opening the door to check the temperature often takes between about 30 and 90 seconds. However, the door may remain open for as long as 3 minutes, or longer, such as when other cooking-related operations are performed while checking the temperature. During these periods in which the door is open, heat storage chamber 26 insulates the sensor chamber and temperature sensor therein from substantial heat exchange with medium 36 due to convection currents entering compartment 54.

Clip 50 typically includes a probe-receiving portion 60 configured to grip probe 14 and a rack-receiving portion 62 configured to grip an elongate bar 52a of rack 52. Clip 50 typically is stamped from a single sheet of metal, and includes split segments 64, 66. Probe-receiving portion 60 typically defines a probe-receiving opening formed between split segments 64, 66. Likewise, rack-receiving portion 62 typically defines a rack-receiving opening formed between split segments 64, 66. A fastener 68 is configured to draw each of split segments 64, 66 together to secure elongate bar 52a within the rack-receiving portion 62 and simultaneously to secure probe 14 within probe-receiving portion 60. Alternatively, clip 50 may be of an alternate suitable shape and form, and need not be stamped.

Thermometer 10′ is shown in FIG. 2 attached to elongate bar 52b by clip 50′ in an above-the-bar orientation. The thermometer is configured to rotate within clip 50′ until the temperature scale 18′ is right-side-up, or in some other predetermined orientation desired by the user. Once properly oriented, the user may tighten fastener 68′ to secure the thermometer 10′ within the clip and to secure the clip to elongate bar 52b, as described above. Therefore, the thermometer of the present invention may be mounted either above or below the rack, or at virtually any angle to the rack, with the temperature scale right-side-up and easily readable by the user. Once installed, the thermometer provides a stable temperature reading for the temperature within compartment 54.

While the invention has been disclosed in its preferred form, the specific embodiments thereof as disclosed and illustrated herein are not to be considered in a limiting sense as numerous variations are possible. The subject matter of the invention includes all novel and non-obvious combinations and subcombinations of the various elements, features, functions and/or properties disclosed herein. No single feature, function, element or property of the disclosed embodiments is essential. The following claims define certain combinations and subcombinations which are regarded as novel and non-obvious. Other combinations and subcombinations of features, functions, elements and/or properties may be claimed through amendment of the present claims or presentation of new claims in this or a related application. Such claims are also regarded as included within the subject matter of the present invention irrespective of whether they are broader, narrower, or equal in scope to the original claims.

I claim:

1. A thermometer configured to measure the temperature of a medium, the thermometer comprising:
a sensor chamber;
a temperature sensor positioned within the sensor chamber; and
a heat storage chamber positioned adjacent the sensor chamber, the temperature sensor being thermally coupled to the medium through sensor chamber and the heat storage chamber such that heat energy may be exchanged between the medium and the temperature sensor.

2. The thermometer of claim 1, wherein the heat storage chamber has a heat capacity sufficient to store thermal energy from the medium, and to maintain the temperature of the thermometer substantially at the temperature of the medium for a predetermined period of time when the temperature of the medium fluctuates.

3. The thermometer of claim 11, wherein the heat storage chamber contains a thermal insulator.

4. The thermometer of claim 3, wherein the thermal insulator is a liquid.

5. The thermometer of claim 4, wherein the thermal insulator is an oil.

6. The thermometer of claim 4, wherein the thermal insulator is hydraulic fluid.

7. The thermometer of claim 1, wherein the heat storage chamber encloses the sensor chamber.

8. The thermometer of claim 1, wherein the heat storage chamber and the sensor chamber are concentrically spaced cylinders.

9. The thermometer of claim 1, wherein the sensor chamber is closed to contain air, and the heat storage chamber is closed to contain the sensor chamber surrounded by a thermal insulator.

10. The thermometer of claim 1, wherein the temperature sensor is a bimetallic element.

11. The thermometer of claim 10, wherein the temperature sensor is substantially helical.

12. The thermometer of claim 1, further comprising an indicator coupled to the temperature sensor, the indicator being configured to indicate a temperature value sensed by the temperature sensor.

13. The thermometer of claim 16, wherein the indicator is a dial indicator including a needle configured to point to a temperature value on a temperature scale.

14. A thermometer for measuring the operating temperature of a compartment having a door, where opening the door of the compartment alters the temperature within the compartment, the thermometer comprising:
a temperature sensor;
an indicator coupled to the temperature sensor, the indicator being configured to indicate a temperature value measured by the temperature sensor;
a double-walled probe including an inner wall and an outer wall surrounding the inner wall, a space between the outer wall and the inner wall defining a heat storage chamber filled with a thermal insulator, and a space within the inner wall defining a sensor chamber filled with air;
where the temperature sensor is positioned within the sensor chamber, and the heat storage chamber is configured to insulate the sensor chamber and temperature sensor from intermittent temperature fluctuations caused by opening the door of the compartment.

15. The thermometer of claim 14, wherein the thermal insulator is a liquid.

16. The thermometer of claim 14, wherein the thermal insulator is an oil.

17. The thermometer of claim 14, wherein compartment further includes a rack, and the thermometer further comprises:
an elongate clip including a probe-receiving bore at one end of the clip and a rack receiving bore at an opposite end of the clip, the probe-receiving bore being configured to mount to the probe, and the rack-receiving bore being configured to mount to the rack, to selectively secure the thermometer to the rack.

18. The thermometer of claim 14, wherein the temperature sensor is a bimetallic temperature sensor.

19. The thermometer of claim 18, wherein the bimetallic temperature sensor is substantially helical.

20. A thermometer configured to measure the temperature of a medium, the thermometer comprising:
a substantially cylindrical sensor chamber closed to contain air;
a temperature sensor positioned within the sensor chamber;
a substantially cylindrical heat storage chamber enclosing the sensor chamber, the heat storage chamber containing a liquid thermal insulator; and
an indicator coupled to the temperature sensor, the indicator being configured to indicate a temperature value sensed by the temperature sensor;
wherein the temperature sensor is thermally coupled to the medium through the sensor chamber and the heat storage chamber such that heat energy may be exchanged between the medium and the temperature sensor; and
wherein the heat storage chamber has a heat capacity sufficient to store thermal energy from the medium, and to maintain the temperature of the thermometer substantially at the temperature of the medium for a predetermined period of time when the temperature of the medium fluctuates.

21. The thermometer of claim 20, wherein the thermal insulator is hydraulic fluid.

22. The thermometer of claim 20, wherein the temperature sensor is a helical bimetallic element.
